(19) United States
(12) Patent Application Publication
(10) Pub. No.: US 2012/0099050 A1
(43) Pub. Date: Apr. 26, 2012

(54) ILLUMINATION DEVICE, DISPLAY DEVICE, AND TELEVISION RECEIVER

(75) Inventors: Nobuhiro Kasai, Osaka (JP); Yasumori Kuromizu, Osaka (JP)

(73) Assignee: SHARP KABUSHIKI KAISHA, Osaka (JP)

(21) Appl. No.: 13/382,186

(22) PCT Filed: Mar. 17, 2010
(86) PCT No.: PCT/JP2010/054516

§ 371 Date: Jan. 4, 2012

(30) Foreign Application Priority Data
Jul. 9, 2009 (JP) 2009-162446

(51) Int. Cl. G02F 1/13357; F21V 7/00; F21V 13/04; G09F 13/04

(52) U.S. Cl. 349/64; 362/97.1

(57) ABSTRACT

A backlight unit (49) of a display device (69) provided with a liquid crystal display panel (59) includes: a chassis (41); a diffusion plate (43) supported by the chassis; light emitting modules (MJ) arranged on mounting substrates (21) on the chassis, the light emitting module being provided with light emitting elements (22) and diffusion lenses (24) which cover the light emitting elements (22); and a reflective sheet (42) for totally covering the chassis and reflecting the light, which is emitted from the light emitting modules (MJ), toward the diffusion plate. A cover section (42C) is formed on the reflective sheet, and the cover section (42C) receives and covers a connector (25) that electrically connects the mounting substrates to each other.

### TECHNICAL FIELD

The present invention relates to an illumination device, to a display device including the aforementioned illumination device, and to a television receiver equipped with the aforementioned display device.

### BACKGROUND ART

A display device using a non-light emitting display panel, that is, a liquid crystal display panel, for example, is usually combined with an illumination device that irradiates the display panel from behind. As a light source for this type of illumination device, various kinds such as cold cathode tubes and light emitting elements are used. Light emitting diodes (hereinafter referred to as “LEDs”), organic electroluminescence elements, inorganic electroluminescence elements or the like are used as the light emitting elements, but LEDs are the mainstream nowadays. The light source for an illumination device described in Patent Document 1 is also LEDs.

In the illumination device described in Patent Document 1, as shown in FIG. 21, LEDs 122 are mounted on a mounting substrate 121, and lenses 124 covering the LEDs 122 are further attached to the mounting substrate 121. The mounting substrate 121, an LED 122, and a lens 124 constitute a light emitting module “mj.” A large number of the light emitting modules “mj” are arranged in a matrix, and constitute a planar light source.

A large number of point-like light sources are arranged in the illumination device described in Patent Document 1, but a large number of linear light sources such as cold cathode tubes are arranged in an illumination device described in Patent Document 2.When an illumination device in which a plurality of light sources are arranged in this way is combined with a display device, an unevenness in brightness is caused on the screen if light from the light sources directly enters the illumination device, and therefore, a diffusion plate for diffusing light is interposed between the light sources and the display device. As also shown in Patent Document 2, it is common that a diffusion plate is configured as a part of the illumination device.

Light sources in a state of being fixed to a mounting substrate are attached to a chassis of the illumination device. The mounting substrate is not expected to reflect light much, and therefore, the mounting substrate is usually covered by a reflective sheet, and only light sources are exposed from the reflective sheet. An example of such an illumination device equipped with a reflective sheet can be seen in Patent Document 3.

### RELATED ART DOCUMENTS

### Patent Documents

Patent Document 1: Japanese Patent Application Laid-Open Publication No. 2008-41546

Patent Document 2: Japanese Patent Application Laid-Open Publication No. 2005-19065

Patent Document 3: Japanese Patent Application Laid-Open Publication No. 2008-152101

### SUMMARY OF THE INVENTION

### Problems to be Solved by the Invention

When a plurality of point-like light sources are arranged to constitute a planar light source, if an area requiring illumination becomes larger, it sometimes becomes necessary to have a configuration in which a plurality of mounting substrates, each of which supports a plurality of point-like light sources, are arranged, and the mounting substrates are connected to each other by connectors. Such a configuration example is shown in FIG. 22. In the configuration of FIG. 22, three reed-shaped mounting substrates 102, each of which has three point-like light sources 101 arranged along the longitudinal direction, are aligned in series such that they form a line along the longitudinal direction, and the mounting substrates 102 are electrically connected to each other by connectors 103. Five sets of such a combination of three mounting substrates 102 are arranged in parallel with each other, and as a result, a total of 45 point-like light sources 101 are arranged in a matrix. All of these mounting substrates 102 are covered by a reflective sheet 104. In the reflective sheet 104, through-holes 105 for exposing the point-like light sources 101 are formed as many as the number of the point-like light sources 101.

The reflective sheet 104 is fixed to the mounting substrates 102 by a fastening means such as resin pins, resin rivets, and screws. Meanwhile, the linear expansion coefficient of the reflective sheet 104 is different from the linear expansion coefficient of the mounting substrates 102. Therefore, if the mounting substrates 102 and the reflective sheet 104 expand or contract due to a change in temperature, warpage or deflection occurs in the reflective sheet 104 due to a difference in the amount of expansion and contraction. The shape of the reflective sheet 104 becomes especially unstable above the connectors 103.

When the shape of the reflective sheet 104 becomes unstable, a shadow may appear on the diffusion plate 106 (FIG. 23), which receives reflected light from there. The shadow may be a shadow that has a certain expansion as shown by S1 in FIG. 23, or may be a relatively small shadow as shown by S2 in the same figure. In either case, the illumination quality is deteriorated if a shadow appears on the diffusion plate 106, and therefore, it is necessary to prevent a shadow from appearing.

The above-mentioned connectors 103 are for connecting the mounting substrates 102 to each other, but connectors for electrical connection may be formed between the mounting substrates 102 and the chassis to which the mounting substrates are attached. The connectors for such purpose may also cause a shadow on the diffusion plate 106 in a way similar to the connectors 103.

The present invention is devised in light of the above-mentioned points, and its object is, in an illumination device including a diffusion plate, a chassis that supports the diffusion plate, light sources that are fixed to mounting substrates arranged on the chassis and that emit light onto the diffusion plate, and a reflective sheet that completely covers the chassis and that reflects light emitted from the light sources toward the diffusion plate, to prevent a shadow from appearing on the aforementioned diffusion plate by suppressing warpage and deflection of the reflective sheet caused by a difference in the linear expansion coefficient between the aforementioned reflective sheet and the aforementioned mounting substrates to which the reflective sheet is attached.

### Means for Solving the Problems

According to a preferred embodiment of the present invention, an illumination device includes a diffusion plate; a chassis supporting the diffusion plate; light sources disposed on the chassis to emit light towards the diffusion plate; and a reflective sheet disposed on mounting substrates that are arranged on the chassis to reflect light emitted from the light sources toward the diffusion plate, wherein the mounting substrates are electrically connected to each other by a connector, and a cover section that receives and covers the connector is formed in the reflective sheet.

If the connectors are simply covered by the reflective sheet, a bulge caused by the connectors naturally appears in the reflective sheet. The shape of this bulge is unstable, and an irregular shadow is likely to appear on the diffusion plate. To solve this issue, if a cover section that receives the connectors as well as covers the connectors is formed in the reflective sheet in advance, the shape of the cover section can be stabilized, and it is also possible to design the shape of the cover section by taking the reflective condition into account from the beginning, and thereby prevents a lowering of the illumination quality due to an unexpected shadow appearing on the diffusion plate.

According to a preferred embodiment of the present invention, in the illumination device of the above-mentioned configuration, the cover section has a slope.

According to a preferred embodiment of the present invention, in the illumination device of the above-mentioned configuration, the cover section has a dome-shaped cross-section.

With this configuration, it is possible to easily obtain a cover section that is unlikely to deform.

According to a preferred embodiment of the present invention, in the illumination device of the above-mentioned configuration, the cover section has a triangular cross-section.

With this configuration, it is possible to obtain a cover section that has superior front light collecting characteristics. The production is also easy, and therefore, the production cost can be lowered.

According to a preferred embodiment of the present invention, in the illumination device of the above-mentioned configuration, the cover section has a trapezoidal cross-section.

With this configuration, due to an increase of sloped sections, it is possible to obtain a cover section that has superior front light collecting characteristics. The production is also easy, and therefore, the production cost can be lowered.

According to a preferred embodiment of the present invention, in the illumination device of the above-mentioned configuration, the cover section has a quadrangular cross-section.

With this configuration, it is possible to obtain a cover section that has superior front light collecting characteristics.

According to a preferred embodiment of the present invention, in the illumination device of the above-mentioned configuration, the cover section has a continuous shape commonly used for a plurality of the connectors.

With this configuration, it is possible to efficiently form the cover section.

According to a preferred embodiment of the present invention, in the illumination device of the above-mentioned configuration, a cut and raised section that is formed by making a cut in the reflective sheet, and by being lifted by the connectors constitutes the cover section.

With this configuration, it is possible to easily and simply form the cover section.

According to a preferred embodiment of the present invention, in the illumination device of the above-mentioned configuration, the cut in the reflective sheet has an H-shape.

According to a preferred embodiment of the present invention, in the illumination device of the above-mentioned configuration, the cut in the reflective sheet has an X-shape.

According to a preferred embodiment of the present invention, in the illumination device of the above-mentioned configuration, the cut in the reflective sheet has a cross-shape.

According to a preferred embodiment of the present invention, in the illumination device of the above-mentioned configuration, the cut in the reflective sheet forms the cut and raised section in an L-shape.

According to a preferred embodiment of the present invention, in the illumination device of the above-mentioned configuration, the cut in the reflective sheet forms the cut and raised section in a concave shape.

According to a preferred embodiment of the present invention, in the illumination device of the above-mentioned configuration, the cut in the reflective sheet forms the cut and raised section in a convex shape.

According to a preferred embodiment of the present invention, in the illumination device of the above-mentioned configuration, the cut in the reflective sheet forms the cut and raised section in a triangle shape.

According to a preferred embodiment of the present invention, in the illumination device of the above-mentioned configuration, the cut in the reflective sheet forms the cut and raised section in a quadrangle shape.

According to a preferred embodiment of the present invention, in the illumination device of the above-mentioned configuration, the cut in the reflective sheet forms the cut and raised section in a claw shape.

According to a preferred embodiment of the present invention, in the illumination device of the above-mentioned configuration, the cut in the reflective sheet is formed by a straight line.

According to a preferred embodiment of the present invention, in the illumination device of the above-mentioned configuration, the cut in the reflective sheet is formed by a curved line.

According to a preferred embodiment of the present invention, in the illumination device of the above-mentioned configuration, the light sources are constituted of light emitting modules including light emitting elements arranged on the mounting substrates, and diffusion lenses that cover the light emitting elements.

With this configuration, light emitted from the light emitting elements becomes wider, and it is possible to cover a broad area with a relatively small number of light emitting elements.

According to a preferred embodiment of the present invention, in the illumination device of the above-mentioned configuration, LEDs are used as the light emitting elements.

With this configuration, it is possible to obtain a bright illumination device by using LEDs, an increase in luminance of which has been remarkable in recent years.

According to a preferred embodiment of the present invention, in the illumination device of the above-mentioned configuration, the LEDs are configured such that a fluorescent member having its emission peak in a yellow region is applied to a blue light emitting chip to emit white light.

According to a preferred embodiment of the present invention, in the illumination device of the above-mentioned configuration, the LEDs are configured such that a fluorescent member having its emission peaks in green and red regions is applied to a blue light emitting chip to emit white light.

According to a preferred embodiment of the present invention, in the illumination device of the above-mentioned configuration, the LEDs are configured such that a fluorescent member having its emission peak in a green region is applied to a blue light emitting chip, and a red light emitting chip is combined thereto, to emit white light.

According to a preferred embodiment of the present invention, in the illumination device of the above-mentioned configuration, the LEDs are configured such that light emitting chips of respective colors of blue, green and red are combined so as to emit white light.

An LED that emits white light is likely to cause an uneven color tone for the reasons such as because the blue tone is too strong. By achieving white light emission in the ways described in the present invention, the color tone can be averaged as a whole, and the illumination light with a mostly even color tone can be achieved.

According to a preferred embodiment of the present invention, in the illumination device of the above-mentioned configuration, in the LEDs, an ultraviolet light chip is combined with a fluorescent member.

According to a preferred embodiment of the present invention, in the illumination device of the above-mentioned configuration, the LEDs are configured such that a fluorescent member having its emission peaks in blue, green, and red regions is applied to an ultraviolet light chip to emit white light.

When an ultraviolet light chip is used as a light source, the color tone would be likely to become uneven, but by using the configurations of the present invention, the color tone can be averaged as a whole, and the illumination light with a mostly even color tone can be obtained.

According to a preferred embodiment of the present invention, in the illumination device of the above-mentioned configuration, a plurality of the mounting substrates are disposed, and adjacent mounting substrates are connected to each other by the connector.

With this configuration, by preparing plural kinds of mounting substrates in different sizes, it is possible to easily accommodate a case of configuring an illumination device in a different size by changing the kind of mounting substrates to be combined, and by connecting them by connector. Accordingly, it is not necessary to design a mounting substrate specific to every size of the illumination device, thereby contributing to the cost reduction.

According to a preferred embodiment of the present invention, in the illumination device of the above-mentioned configuration, the mounting substrates are connected to a power source through the connector.

According to a preferred embodiment of the present invention, in the illumination device of the above-mentioned configuration, the connector is constituted of a combination of connector halves, one of which is attached to one of the adjacent mounting substrates and the other is attached to the other mounting substrate, and at least one of the connector halves protrudes outward beyond an edge of the mounting substrate to which the one of the connector halves is attached.

With this configuration, when connecting adjacent mounting substrates to each other by connectors, at least one of the connector halves protrudes outward beyond the edge of the mounting substrate to which the connector half is attached, and therefore, it is possible to easily connect the connector halves to each other.

According to a preferred embodiment of the present invention, in the illumination device of the above-mentioned configuration, the connector has an outer surface in a light color.

With this configuration, the light reflectance of the connectors is increased, and the connectors are not likely to absorb light, and therefore, it is possible to suppress an occurrence of an unevenness in luminance in the diffusion plate.

According to a preferred embodiment of the present invention, in the illumination device of the above-mentioned configuration, the connector has an outer surface in a dark color.

With this configuration, blot or discoloration of the connectors becomes unlikely to be noticed, and the heat dissipation characteristic of the connectors is also improved.

According to a preferred embodiment of the present invention, a display device including the above-mentioned illumination device and a display panel that receives light from the illumination device is configured.

With this configuration, it is possible to obtain a display device with a reduced unevenness in luminance.

According to a preferred embodiment of the present invention, in the display device of the above-mentioned configurations, the display panel is a liquid crystal display panel.

With this configuration, it is possible to obtain a liquid crystal display device with a reduced unevenness in luminance.

According to a preferred embodiment of the present invention, a television receiver equipped with a display device of the above-mentioned configuration is configured.

With this configuration, it is possible to obtain a television receiver with a reduced unevenness in luminance on the screen.

### Effects of the Invention

According to the present invention, in order to prevent a bulge in an instable shape from appearing in the reflective sheet, a cover section that receives and covers the connectors is formed on the reflective sheet in advance, so that a lowering of illumination quality due to an unexpected shadow appearing on the diffusion plate can be avoided.

### BRIEF DESCRIPTION OF THE DRAWINGS

FIG. 1 is an exploded perspective view of a display device including an illumination device according to a preferred embodiment of the present invention.

FIG. 2 is a partial cross-sectional view of an illumination device according to Embodiment 1.

FIG. 3 is a partial plan view of the illumination device of FIG. 2.

FIG. 4 is a partial cross-sectional view of an illumination device according to Embodiment 2.

FIG. 5 is a partial cross-sectional view of an illumination device according to Embodiment 3.

FIG. 6 is a partial cross-sectional view of an illumination device according to Embodiment 4.

FIG. 7 is a partial cross-sectional view of an illumination device according to Embodiment 5.

FIG. 8 is a partial plan view of an illumination device according to Embodiment 5.

FIG. 9 is a partial plan view of an illumination device according to Embodiment 6.

FIG. 10 is a partial plan view of an illumination device according to Embodiment 7.

FIG. 11 is a partial plan view of an illumination device according to Embodiment 8.

FIG. 12 is a partial plan view of an illumination device according to Embodiment 9.

FIG. 13 is a partial plan view of an illumination device according to Embodiment 10.

FIG. 14 is a partial plan view of an illumination device according to Embodiment 11.

FIG. 15 is a partial plan view of an illumination device according to Embodiment 12.

FIG. 16 is a partial plan view of an illumination device according to Embodiment 13.

FIG. 17 is a partial plan view of an illumination device according to Embodiment 14.

FIG. 18 is a partial plan view of an illumination device according to Embodiment 15.

FIG. 19 is a partial cross-sectional view of an illumination device according to Embodiment 16.

FIG. 20 is an exploded perspective view of a television receiver.

FIG. 21 is an exploded perspective view of a conventional illumination device.

FIG. 22 is a plan view showing a configuration example of an illumination device.

FIG. 23 is a plan view of a diffusion plate included in the illumination device of FIG. 22.

FIG. 24 is a graph showing how illuminance differs depending on an LED's illumination direction.

FIG. 25 is a view showing a collective image of luminance of a plurality of LEDs.

### DETAILED DESCRIPTION OF EMBODIMENTS

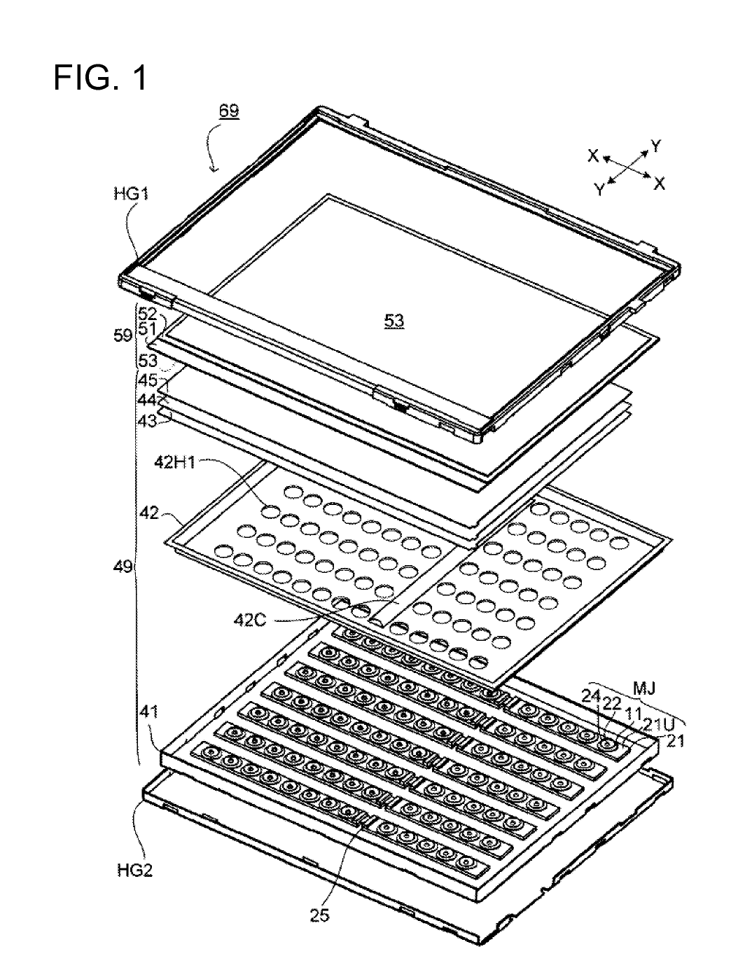

The configuration of an embodiment of a display device equipped with an illumination device according to a preferred embodiment of the present invention will be described with reference to FIGS. 1 to 3. In FIG. 1, a display device 69 is illustrated such that it is placed horizontally with its display surface facing upward.

The display device 69 uses a liquid crystal display panel 59 as the display panel. The liquid crystal display panel 59 and a backlight unit 49 that irradiates the liquid crystal display panel 59 from behind are housed in one housing. The housing is composed by combining a front housing member HG1 and a rear housing member HG2.

The liquid crystal display panel 59 is constructed by bonding an active matrix substrate 51 that includes switching elements such as thin film transistors (TFTs) and an opposite substrate 52 that faces the active matrix substrate 51 together by having a sealing member, which is not shown in the figure, therebetween, and by injecting liquid crystal to a space between the active matrix substrate 51 and the opposite substrate 52.

A polarizing film 53 is attached to a light receiving surface side of the active matrix substrate 51 and an emission side of the opposite substrate 52, respectively. The liquid crystal display panel 59 forms images by using a change in light transmittance caused by inclinations of liquid crystal molecules.

The backlight unit 49, which is an example of an illumination device of the present invention having a specific shape, has the following configuration. That is, the backlight unit 49 includes light emitting modules “MJ”, a chassis 41, a large-sized reflective sheet 42, a diffusion plate 43, a prism sheet 44, and a micro lens sheet 45.

The chassis 41 has a tray-like shape, and rising walls are formed in the outer periphery of the rectangular main flat surface.

A light emitting module MJ includes a mounting substrate 21, point-like light sources arranged on the mounting substrate 21, a lens 24 that covers the point-like light source, and a built-in reflective sheet 11. The point-like light source is formed of a light emitting element mounted on the mounting substrate 21. The light emitting element of the embodiment is an LED 22.

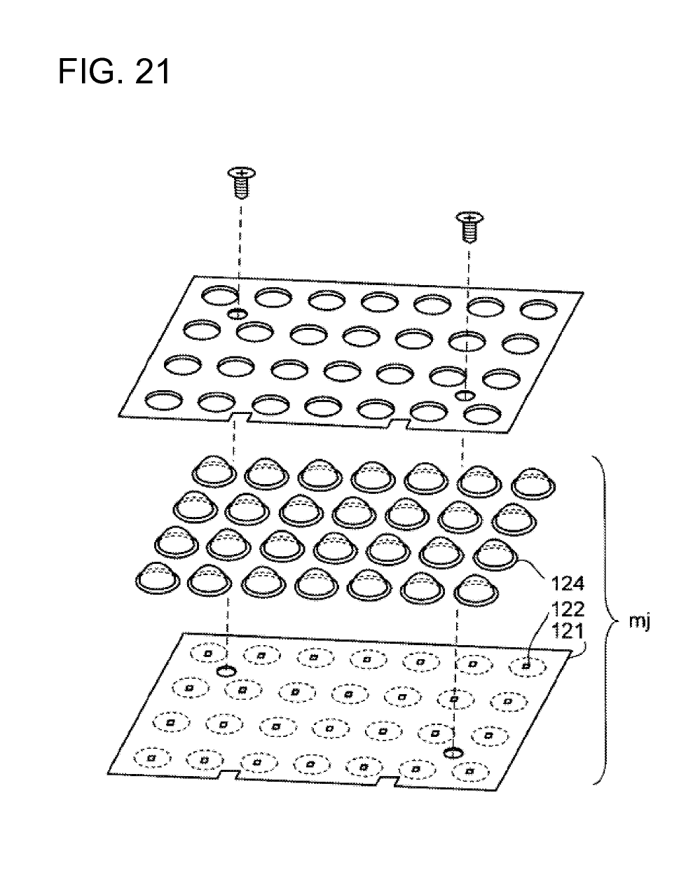

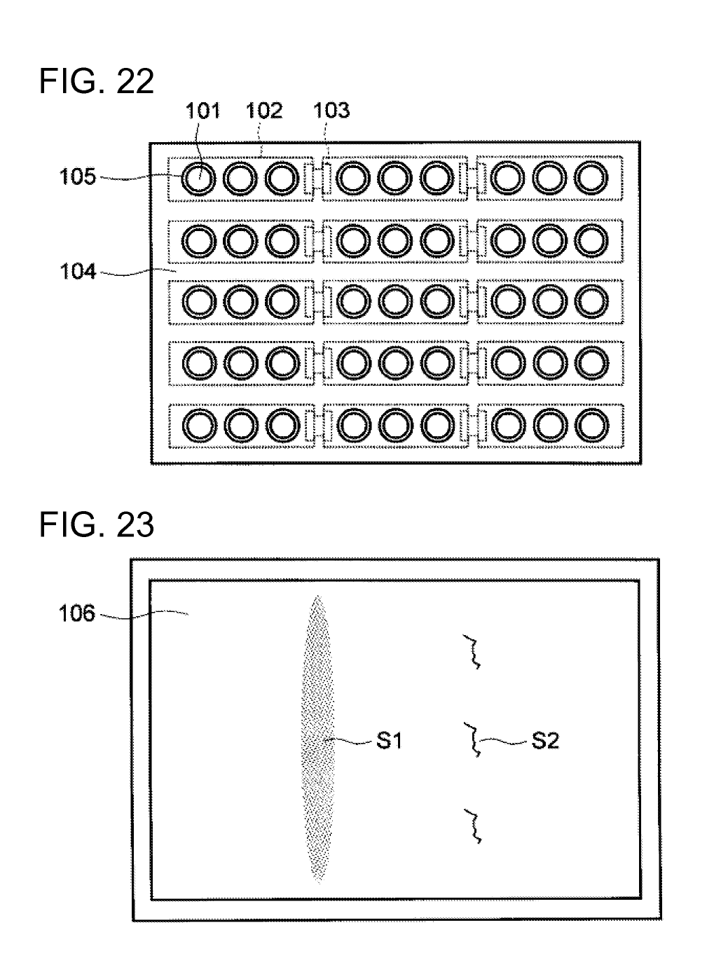

The lens 24 has a light diffusing function. The significance of the light diffusing function of the lens 24 will be described. For example, when taking the illumination device described in Patent Document 1 into consideration, even though the illumination device of FIG. 21 has lenses 124 combined, the spread of light from each of the LEDs 122 is small, and therefore, it is necessary to arrange a large number of light emitting modules “mj” at high density in order to eliminate the unevenness in luminance. Accordingly, the parts cost and the mounting cost become high, resulting in an expensive product as a whole.

The luminance of an LED has been becoming increasingly high in recent years, and it is possible to provide the amount of light for the entire screen with a relatively small number of LEDs. However, if LEDs with high luminance are sparsely arranged, the occurrence of an unevenness in luminance cannot be avoided, and therefore, it is preferable to use a lens having the light diffusing function along with each LED. In the present specification, a lens having the light diffusing function is referred to as a “diffusion lens.”

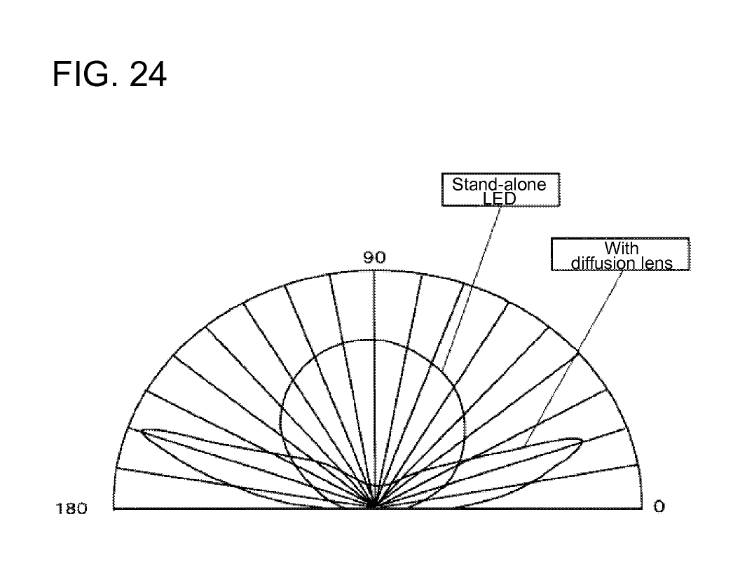

FIG. 24 is a graph showing how illuminance (unit Lux) differs between the illumination directions of a stand-alone LED and that of an LED with a diffusion lens. In the case of a stand-alone LED, having 90 degrees, which is an angle of the light axis, as a peak, the illuminance decreases dramatically as it moves further from there. On the other hand, in the case of an LED with a diffusion lens, it is possible to expand an area where a certain amount of illuminance or more can be secured, and to set a peak illuminance at angles different from the light axis. Further, it is needless to say that the illuminance patterns in the figure can be modified in any way depending on the design of a diffusion lens.

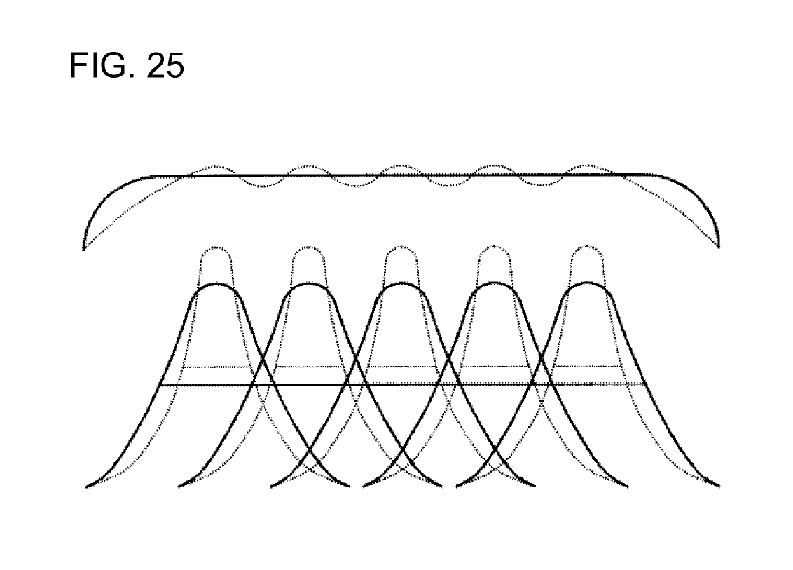

The collective image of luminance of a plurality of LEDs is shown in FIG. 25. In the figure, the waveforms with a solid line represent the luminance of an LED with a diffusion lens, and the waveforms with a dotted line represents the luminance of a stand-alone LED. The horizontal lines inside the waveforms represent the width of the waveforms at the luminance that is half of the peak value (half value width). In the case of an LED with a diffusion lens, it is possible to widen each waveform, and therefore, the luminance as a whole collection can easily be made a flat form as shown by a solid line in the upper side of the figure. However, in the case of a stand-alone LED, while each waveform has a height, the width is narrow, and therefore, it is not possible to avoid waves from appearing in the luminance of the collection of the stand-alone LEDs. Because such an image with an unevenness in luminance is not preferable, it becomes almost essential to employ an LED with a diffusion lens.

In light of the above-mentioned consideration, a light emitting module MJ is configured to include diffusion lenses 24.

It is also possible to add the light diffusing function by performing a surface roughing processing such as a grain processing on the diffusion lens 24 on its surface facing the mounting substrate 21. This way, even better light diffusion can be performed.

The mounting substrate 21 has a long and thin rectangular shape, and on its upper surface, that is, a mounting surface 21U, a plurality of electrodes (not shown in the figure) are formed on a straight line in parallel with the longitudinal direction of the mounting substrate 21 at prescribed intervals, and LEDs 22 are mounted on these electrodes. The mounting substrate 21 becomes a common substrate for a plurality of the LEDs 22. In other words, as shown in FIG. 1, a plurality of the LEDs 22 are arranged on a straight line in parallel with the longitudinal direction of the mounting substrate 21 at prescribed intervals, in this case, at prescribed equal intervals.

A plurality of the LEDs 22 are arranged on the mounting substrate 21 in a shape having a longitudinal direction, and the mounting substrates 21 are installed on the chassis 41. As a result, the work efficiency can be improved as compared to when each of the LEDs 22 is installed on the chassis 41. Further, because a plurality of the LEDs 22 are arranged on a straight line in parallel with the longitudinal direction of the mounting substrates 21, the installation pattern of the LEDs 22 is primarily determined by the installation pattern of the mounting substrates 21, thereby facilitating the designing of the arrangement of the LEDs 22. Because a plurality of the LEDs 22 are arranged on a straight line at equal intervals, the arrangement pattern of the LEDs 22 is not modified because of the mounting substrates 21, and therefore, it is possible to use the mounting substrates 21 even though the size of the backlight unit 49 has been modified.

The diffusion lens 24 has a circular planar shape, and has a plurality of leg parts 24a at the bottom surface, and is attached to the mounting substrate 21 by bonding the tips of the leg parts 24a to the mounting surface 21U of the mounting substrate 21 with an adhesive agent. Because of the leg parts 24a, a gap is formed between the mounting substrate 21 and the diffusion lens 24. The LED 22 is cooled down by airflow that flows through this gap. Here, if a problem of heat dissipation can be solved, it is also possible to use an integrated mold type light emitting module in which an LED is embedded in a diffusion lens.

Various types of LEDs can be used as the LEDs 22. For example, it is possible to use an LED that is configured such that a fluorescent member having its emitting peak in a yellow region is applied to a blue light emitting chip to achieve white light emission. It is also possible to use an LED that is configured such that a fluorescent member having its emission peaks in green and red regions is applied to a blue light emitting chip to achieve white light emission. It is also possible to use an LED that is configured such that a fluorescent member having its emission peak in a green region is applied to a blue light emitting chip, and a red light emitting chip is combined thereto to achieve white light emission. It is also possible to use an LED that is configured such that light emitting chips of respective colors of blue, green, and red are combined to achieve white light emission.

An LED that emits white light is likely to cause an uneven color tone for various reasons such as the blue tone is too strong. By achieving white light emission as described above, the color tone can be averaged as a whole, and the illumination light with a mostly even color tone can be achieved.

As an another type of the LED, it is also possible to use an LED in which an ultraviolet light chip is combined with a fluorescent member, especially, an LED that is configured such that a fluorescent member having its emission peaks in blue, green, and red regions is applied to an ultraviolet light chip to achieve white light emission.

When an ultraviolet light chip is used as a light source, the color tone would be likely to become uneven, but by configuring as described above, the color tone can be averaged as a whole, and the illumination light with a mostly even color tone can be obtained.

In FIG. 1, the mounting substrates 21, each of which has five LEDs 22 aligned, and the mounting substrates 21, each of which has eight LEDs 22 aligned, are used in combination. The mounting substrate 21 having five LEDs 22 and the mounting substrate 21 having eight LEDs 22 are electrically connected to each other by a connector 25. The middle section of the connector 25 is composed of a wire harness 25a.

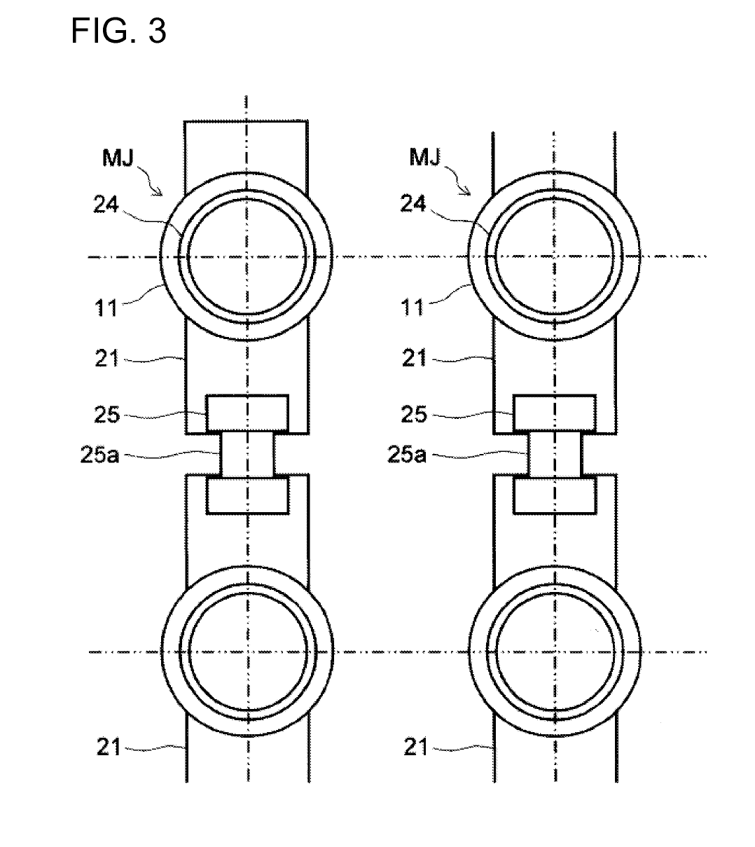

Plural sets of a combination of the mounting substrate 21 having five LEDs 22 and the mounting substrate 21 having eight LEDs 22 that are connected by the connector 25 are arranged on the chassis 41 such that each set becomes parallel to each other. The alignment of the LEDs 22 on the mounting substrates 21 is the long side direction of the chassis 41, which is the direction of the X arrow in FIG. 1, and the direction in which the combination of the two mounting substrates 21 is aligned is the short side direction of the chassis 41, which is the direction of the Y arrow in FIG. 1, and therefore, the LEDs 22 are arranged in a matrix. Each grid of the matrix becomes a rectangular-shape as shown by the virtual lines in FIG. 3. The mounting substrates 21 are fixed to the chassis 41 by an appropriate means such as a swage, bond, a screw fastening, and a rivet fastening.

Because a plurality of the mounting substrates 21 are installed on the chassis 41, and the adjacent mounting substrates 21 are connected to each other by the connectors 25, by preparing plural kinds of the mounting substrates 21 in different sizes, it is possible to construct backlight units 49 with different sizes with ease by changing the kinds of the mounting substrates 21 to be combined, and by connecting them by the connectors 25. Accordingly, it becomes unnecessary to design a mounting substrate 21 specific to every size of the backlight unit 49, thereby contributing to the cost reduction. Moreover, among the mounting substrates 21, ones aligned in the longitudinal direction become the mounting substrates adjacent to each other, and therefore, by preparing plural kinds of the mounting substrates 21 in different lengths, or in other words, the mounting substrates 21 that have a different number of the arranged LEDs 22, it is possible to easily construct backlight units 49 with different sizes with ease.

A built-in reflective sheet 11 is interposed between the mounting substrate 21 and the diffusion lens 24. The built-in reflective sheet 11 is fixed to the mounting surface 21U in the position facing the bottom surface of the diffusion lens 24. The built-in reflective sheet 11 has a higher light reflectance than the mounting substrate 21. The built-in reflective sheet 11 also has a circular planar shape, and forms a concentric circle along with the diffusion lens 24. The built-in reflective sheet 11 has a larger diameter than the diffusion lens 24. Passage holes for having the leg parts 24a of the diffusion lens 24 pass through are formed in the built-in reflective sheet 11.

The chassis 41 is overlapped with a reflective sheet 42 that has a similar tray shape as the chassis 41. The reflective sheet 42 is also a form resin sheet similar to the built-in reflective sheet 11. The periphery of the reflective sheet 42 is placed on the rising walls of the chassis 41, and the main flat surface part on the inner side of the reflective sheet 42 overlaps with the mounting substrates 21. The reflective sheet 42 is fixed to the mounting substrates 21 by fastening means such as resin pins, resin rivets, and screws.

Circular passage holes 42H1, each of which has a size in which the diffusion lens 24 can pass through, but the built-in reflective sheet 11 cannot pass through, are formed in the reflective sheet 42 in the positions corresponding to the light emitting modules MJ.

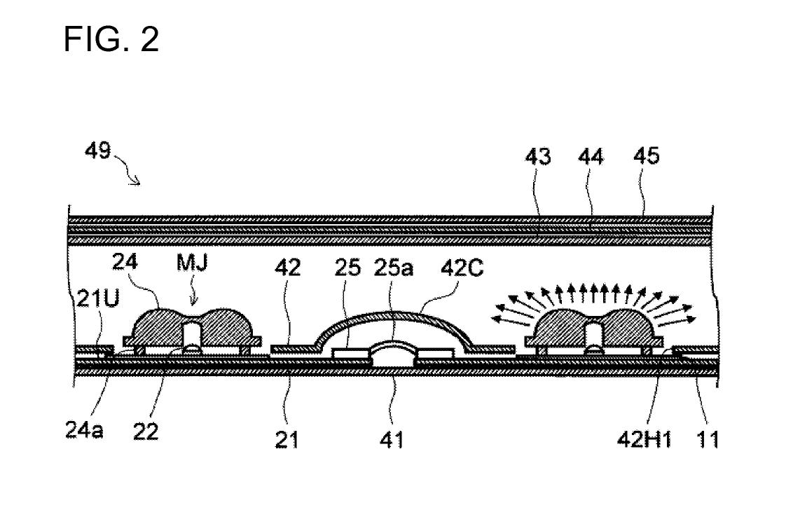

A cover section 42C that receives the connectors 25 as well as covers the connectors 25 is formed in the reflective sheet 42 in the position corresponding to the connectors 25. The cover section 42C has a dome-shaped cross-section as shown in FIG. 2.

The cover section 42C is not formed on a one-on-one basis for each connector 25, but has a continuous shape used commonly for a plurality of the connectors 25. In the backlight unit 49 of Embodiment 1 shown in FIG. 1, the cover section 42C is configured to receive all of the connectors 25, and as a result, the cover section 42C has a ridge-shaped protrusion that almost goes across the reflective sheet 42.

When the LEDs 22 light up, light emitted from the LEDs 22 irradiates the diffusion plate 43 from the back surface. Light that does not directly travel toward the direction of the diffusion plate 43 is reflected toward the diffusion plate 43 by the reflective sheet 42 or the built-in reflective sheet 11. Light is diffused inside the diffusion plate 43, and therefore, the diffusion plate 43 appears to be a surface with a relatively even luminance from outside.

The LEDs 22 in each pair of the mounting substrates 21 connected by the connector 25 can be electrically connected to each other in series, or all of the LEDs 22 can be electrically connected to each other in series. With this configuration, it is possible to supply the same current to each of the LEDs 22, and to even out the amount of light emitted from the respective LEDs 22, and therefore, the luminance uniformity of the diffusion plate 43 can be improved.

Because the cover section 42C, which receives the connectors 25 and covers them, is formed in the reflective sheet 42 in advance, the shape of the cover section 42C can be stabilized. Further, it is possible to design the shape of the cover section 42C by taking the reflective condition into account from the beginning. Therefore, a lowering of illumination quality caused by a shadow such as the ones in FIG. 23 appearing on the diffusion plate 43 is prevented.

Because the cover section 42C has a dome-shaped cross-section, it is not likely to deform. Moreover, because the cover section 42C has a continuous shape used commonly for a plurality of the connectors 25, the cover section 42C can be formed effectively. However, the cover section 42C does not need to be a protrusion having a length that receives all of the connectors 25. A plurality of short protrusions, each of which receives a small number of the connectors 25 such as two or three, may also be formed. It is also possible to have a configuration in which protrusions, each of which receives only one of the connectors 25, are formed as many as the number of the connectors 25.

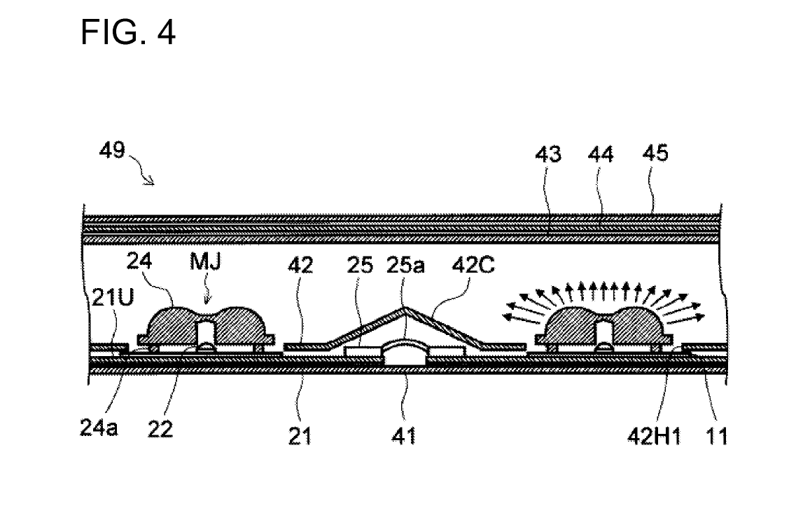

Embodiment 2 of the backlight unit 49 is shown in FIG. 4. In Embodiment 2, the cover section 42C has a triangle cross-section. The cover section 42C having a triangle cross-section has superior front light collecting characteristics, and the production is easy. Therefore, the production cost can be lowered.

Like Embodiment 1, the cover section 42C of Embodiment 2 may be a ridge-shaped protrusion having a length that can receive all of the connectors 25; may be a plurality of short protrusions, each of which receives a small number of the connectors 25 such as two or three; or may be protrusions, each of which receives only one of the connectors 25, formed as many as the number of the connectors 25.

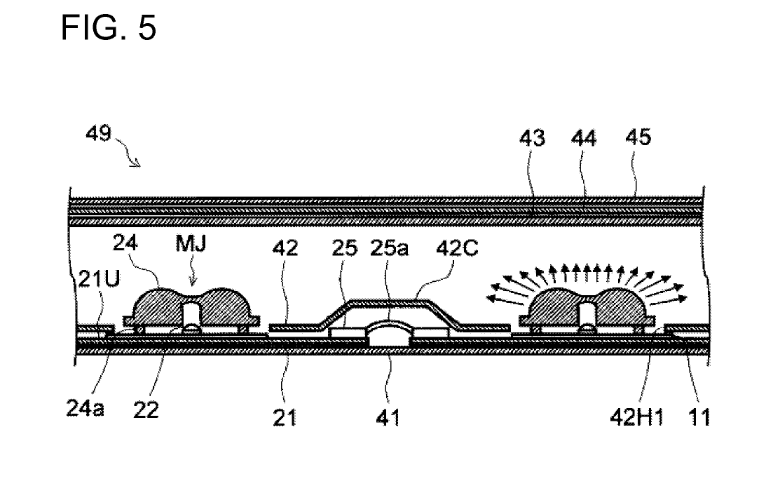

Embodiment 3 of the backlight unit 49 is shown in FIG. 5. In Embodiment 3, the cover section 42C has a trapezoidal cross-section. The cover section 42C having a trapezoidal cross-section has superior front light collecting characteristics due to an increase in the sloped sections, and the production is easy. Therefore, the production cost can be lowered.

Like Embodiment 1, the cover section 42C of Embodiment 3 may be a ridge-shaped protrusion having a length that can receive all of the connectors 25; may be a plurality of short protrusions, each of which receives a small number of the connectors 25 such as two or three; or may be protrusions, each of which receives only one of the connectors 25, formed as many as the number of the connectors 25.

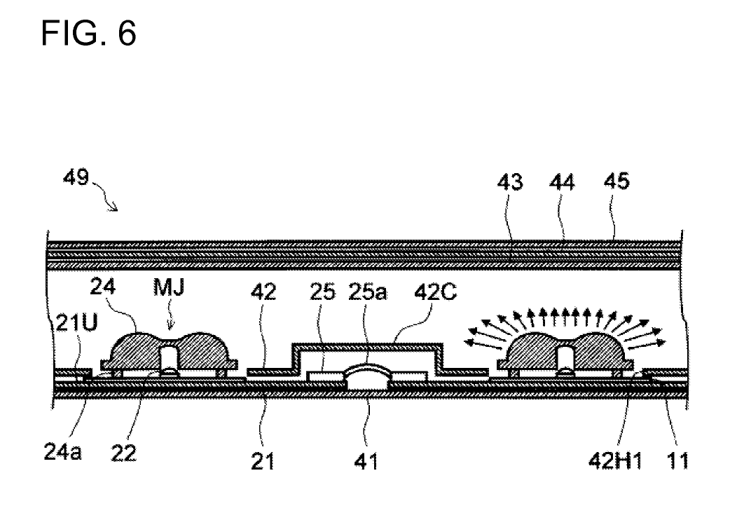

Embodiment 4 of the backlight unit 49 is shown in FIG. 6. In Embodiment 4, the cover section 42C has a quadrangular cross-section. The cover section 42C having a quadrangular cross-section has superior front light collecting characteristics, and the production is easy. Therefore, the production cost can be lowered.

Like Embodiment 1, the cover section 42C of Embodiment 4 may be a ridge-shaped protrusion having a length that can receive all of the connectors 25; may be a plurality of short protrusions, each of which receives a small number of the connectors 25 such as two or three; or may be protrusions, each of which receives only one of the connectors 25, formed as many as the number of the connectors 25.

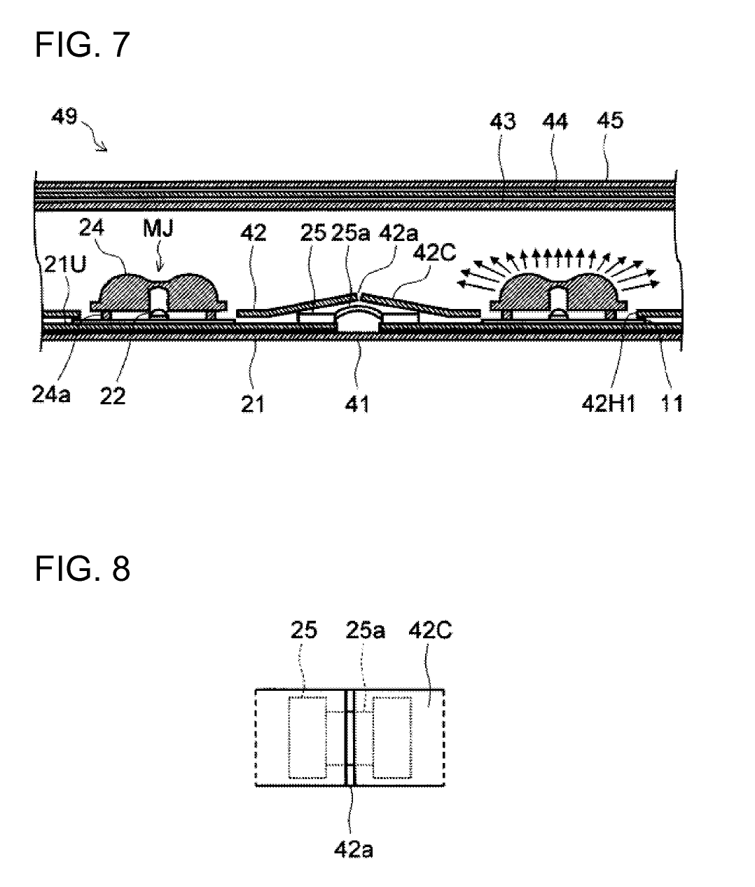

Embodiment 5 of the backlight unit 49 is shown in FIGS. 7 and 8. In Embodiment 5, by adding an H-shaped cut 42a in the reflective sheet 42, two rectangular cut and raised sections, each of which is connected to the reflective sheet 42 at its root, are formed. These cut and raised sections become the cover section 42C. When the reflective sheet 42 is laminated on the mounting substrate 21, the cut and raised sections are lifted up by the connector 25. If a space between the respective tips of the cut and raised sections becomes too large as a result of being lifted up by the connector 25, the function of the reflective sheet 42 is lowered, and therefore, in order to avoid that, the height of the connector 25 and the size of the cut 42a should be properly set. It is considerably easy and simple to form the cover section 42C by the cut 42a.

The cover section 42C shown in FIG. 8 has a narrow width, and only covers one of the connectors 25, but it is also possible to expand the width to cover a plurality of the connectors 25.

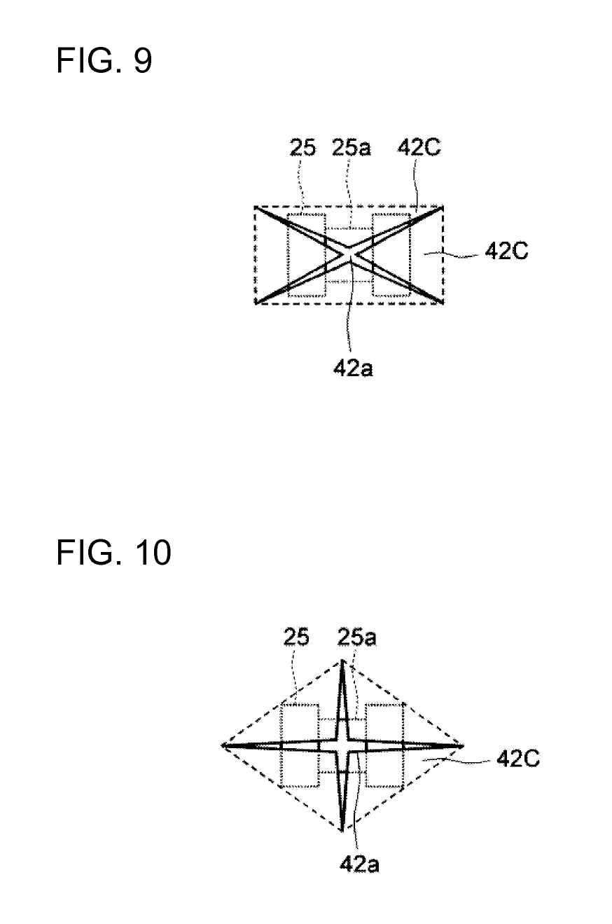

Embodiment 6 of the backlight unit 49 is shown in FIG. 9. Embodiment 6 is a slightly modified version of Embodiment 5. That is, the cut 42a has an X-shape instead of an H-shape. Accordingly, four cut and raised sections, each of which is in an isosceles triangle shape and is connected to the reflective sheet 42 at its root, are formed. The cover section 42C can be easily and simply formed by this method as well.

Embodiment 7 of the backlight unit 49 is shown in FIG. 10. Embodiment 7 is also a slightly modified version of Embodiment 5. That is, the cut 42a has a cross-shape instead of an H-shape. Accordingly, four cut and raised sections, each of which is in a right triangle shape and is connected to the reflective sheet 42 at its root, are formed. The cover section 42C can be easily and simply formed by this method as well.

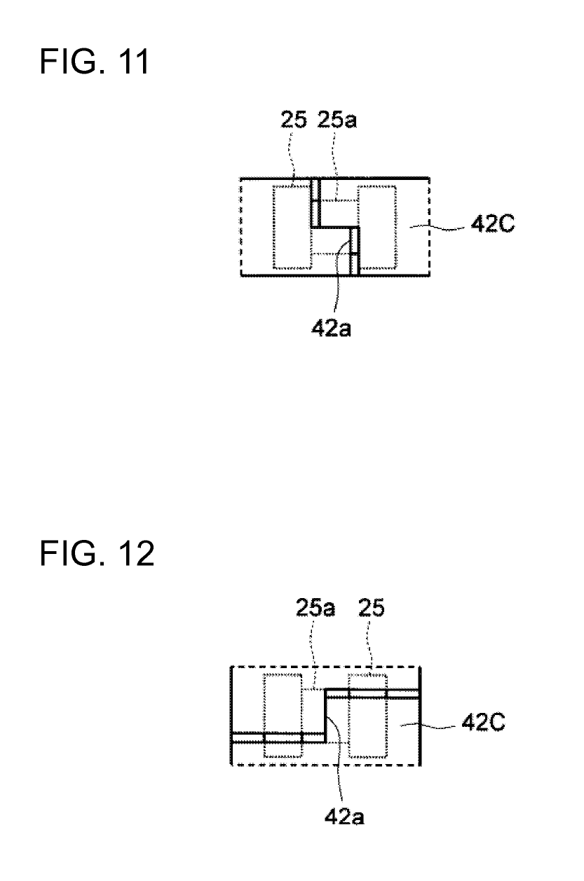

Embodiment 8 of the backlight unit 49 is shown in FIG. 11. In Embodiment 8, the cut 42a has a shape in which the horizontal line of an H-shape is in a crank shape. Accordingly, two cut and raised sections, each of which is in an L-shape and is connected to the reflective sheet 42 at its root, are formed. The cover section 42C can be easily and simply formed by this method as well.

Embodiment 9 of the backlight unit 49 is shown in FIG. 12. Embodiment 9 is a modification of Embodiment 8. That is, the crank-shaped horizontal line of an H-shape is disposed along the longitudinal direction of the connector 25. Accordingly, two cut and raised sections, each of which is in an L-shape that is different from the shape of Embodiment 8, are formed. The cover section 42C can be easily and simply formed by this method as well.

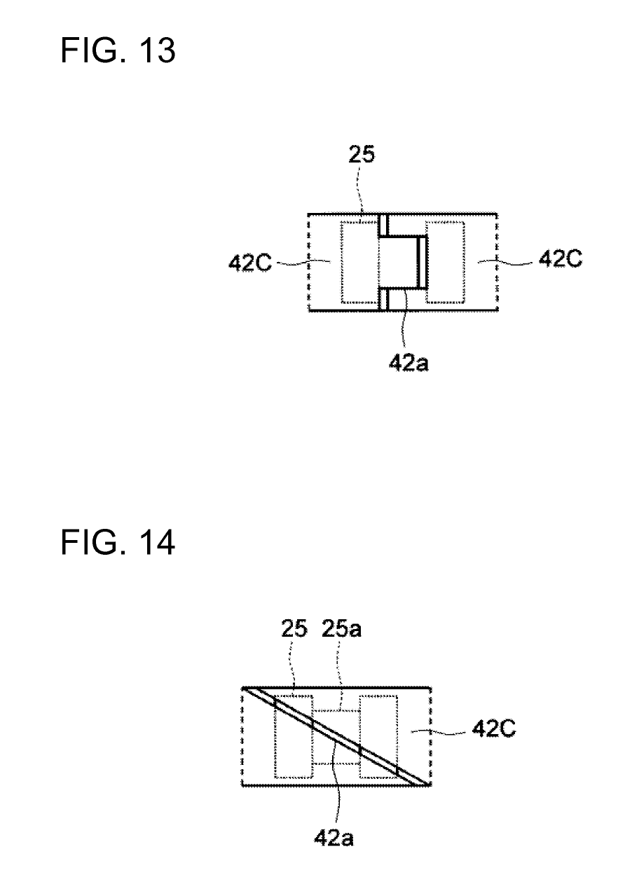

Embodiment 10 of the backlight unit 49 is shown in FIG. 13. In Embodiment 10, the cut 42a has a shape in which the horizontal line of an H-shape is in a concave shape or a convex shape. Accordingly, a cut and raised section in a concave shape and a cut and raised section in a convex shape, each of which is connected to the reflective sheet 42 at its root, are formed one for each. The cover section 42C can be easily and simply formed by this method as well.

Embodiment 11 of the backlight unit 49 is shown in FIG. 14. In Embodiment 11, the cut 42a has a Z-shape or an N-shape instead of an H-shape. Accordingly, two cut and raised sections, each of which is in a right triangle shape and is connected to the reflective sheet 42 at its root, are formed. The cover section 42C can be easily and simply formed by this method as well.

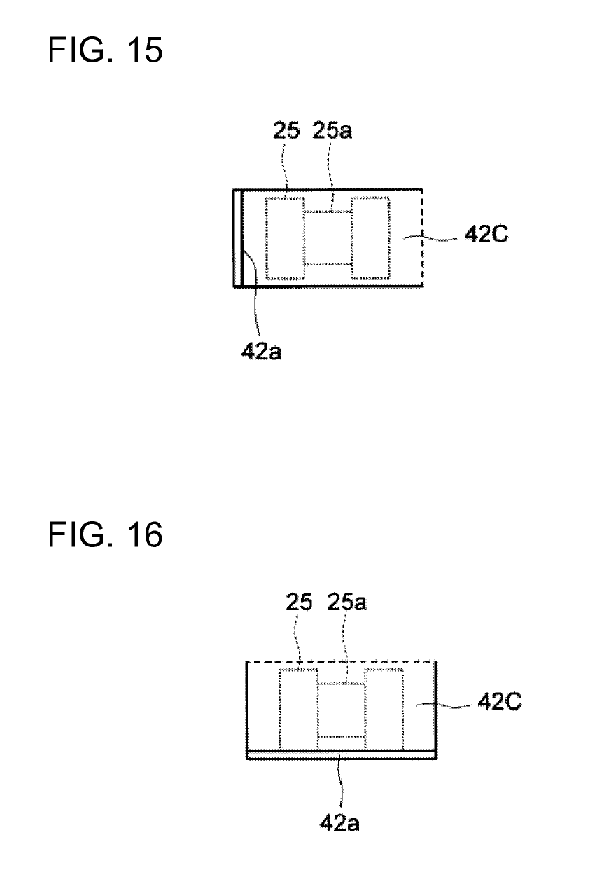

Embodiment 12 of the backlight unit 49 is shown in FIG. 15. In Embodiment 12, the cut 42a has a U-shape. Accordingly, one cut and raised section in a quadrangular shape, which is connected to the reflective sheet 42 at its root, is formed. The cover section 42C can be easily and simply formed by this method as well.

Embodiment 13 of the backlight unit 49 is shown in FIG. 16. Embodiment 13 is a modification of Embodiment 12. That is, the direction of the U-shape of the cut 42a has been rotated by 90 degrees. Accordingly, one wide cut and raised section is formed. The cover section 42C can be easily and simply formed by this method as well.

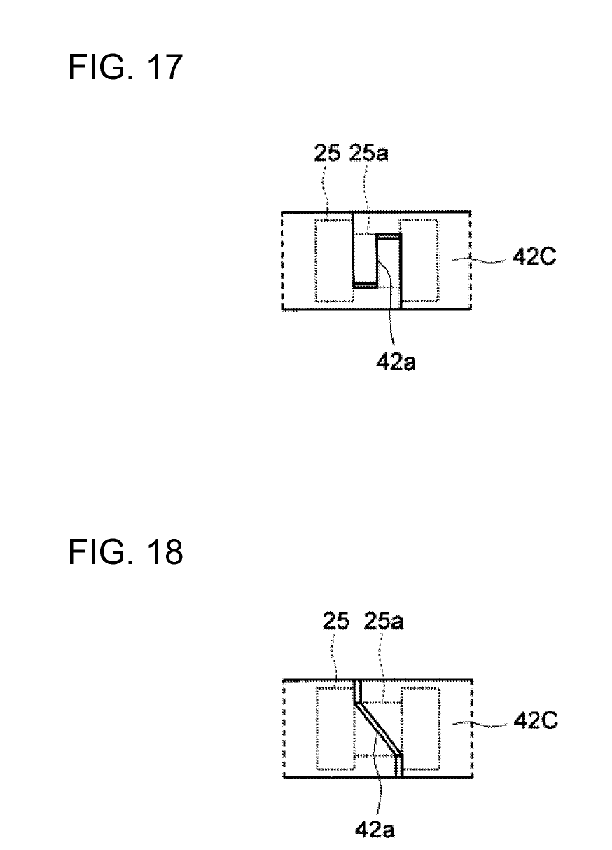

Embodiment 14 of the backlight unit 49 is shown in FIG. 17. In Embodiment 14, the shape of the cut 42a is in a shape such that two cut and raised sections, each in a claw shape, are interlocking with each other. The cover section 42C can be easily and simply formed by this method as well.

Embodiment 15 of the backlight unit 49 is shown in FIG. 18. In Embodiment 15, the cut 42a has an H-shape in which the horizontal line thereof has an oblique section. Accordingly, two cut and raised sections, each in a modified L-shape, are formed. The cover section 42C can be easily and simply formed by this method as well.

In Embodiments 5 through 15, the cut 42a is formed by straight lines, but a part of or the entire cut 42a may also be formed by curved lines.

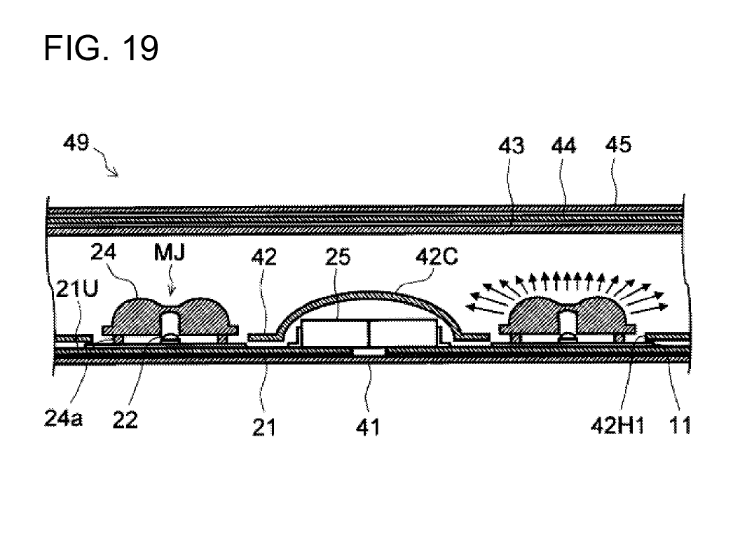

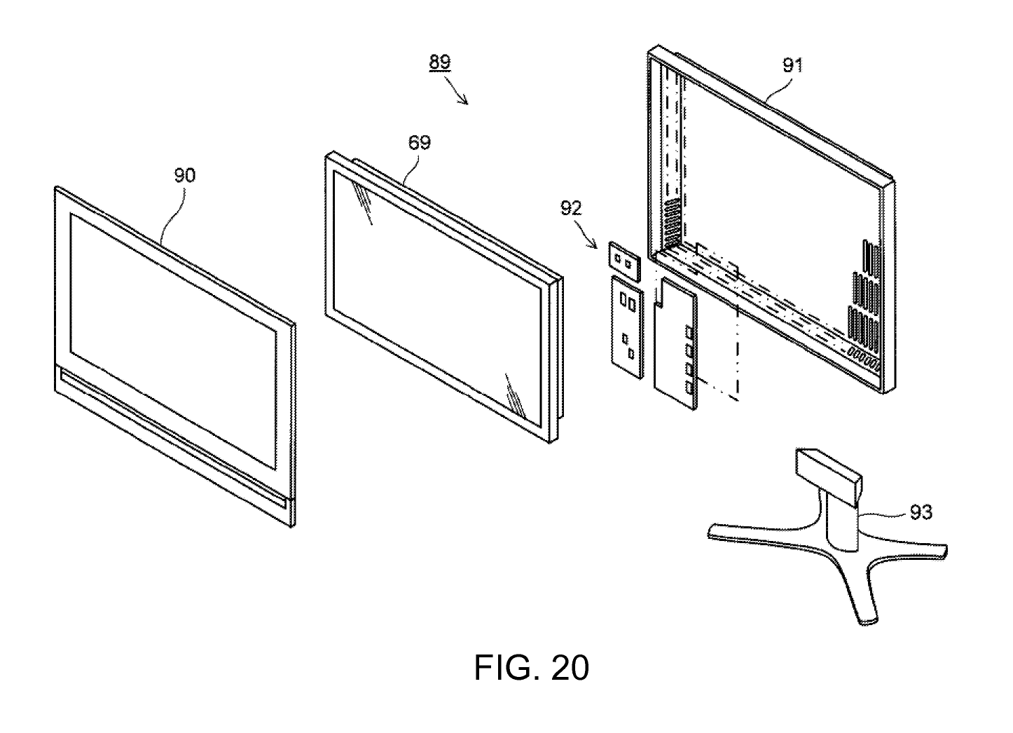

The connector 25 is not limited to a connector in which its middle section is composed of a wire harness. Any form may be used. As Embodiment 16 of the backlight unit, FIG. 19 shows an example using a male and female type connector 25 that is composed of a plug type connector half and a socket type connector half. The cover section 42C in FIG. 19 has a dome-shape, but the cover section 42C may have any shape shown in Embodiments 2 to 5, or may also be a cover section in any other shape.

In Embodiment 16, the respective connector halves are attached to the adjacent mounting substrates 21 in the respective edges facing each other. At least one of the connector halves protrudes outward beyond the edge of the mounting substrate 21 to which the connector half is attached. With this structure, it is possible to easily connect the connector halves to each other. Here, in Embodiment 16, both of the connector halves protrude outward beyond the edge of the respective mounting substrates 21.

In the cases of Embodiments 5 to 15, a part of the connector 25 may be exposed from the cut 42a. In such a case, the light reflectance of the connector 25 itself has an impact on the luminance of the diffusion plate 43. Therefore, the connector 25 is configured to have a light color in the outer surface, which is a section that is exposed to outside when the mounting substrates 21 are connected to each other. In other words, by selecting a material for or by painting the outer shell part of the connector 25, the outer surface is configured to have a light color such as white, ivory, or light gray. Accordingly, the light reflectance of the connector 25 is increased, and the connector 25 becomes unlikely to absorb light, and therefore, it is possible to suppress the occurrence of an unevenness in luminance on the diffusion plate 43.

Contrary to the foregoing, it is also possible to configure the outer surface of the connector 25 to have a dark color. That is, by selecting a material for or by painting the outer shell part of the connector 25, the outer surface is configured to have a dark color such as darkish gray or black. Accordingly, blot or discoloration of the connector 25 becomes unlikely to be noticed, and the heat dissipation characteristic of the connector 25 is also improved.

FIG. 20 shows a configuration example of a television receiver in which the display device 69 is mounted. The television receiver 89 has a configuration in which the display device 69 and a group of control boards 92 are housed in a cabinet composed of a combination of a front cabinet 90 and a rear cabinet 91, and in which a stand 93 supports the cabinet.

Embodiments of the present invention have been described above, but the scope of the present invention is not limited to them, and it is possible to implement various modifications without departing from the main purpose of the invention.

### INDUSTRIAL APPLICABILITY

The present invention can be used widely for an illumination device in which light from light sources is emitted onto a diffusion plate. Further, it is also possible to use the present invention widely for a display device including the aforementioned illumination device, and a television receiver equipped with the aforementioned display device.

### DESCRIPTION OF REFERENCE CHARACTERS

49 Backlight unit

41 Chassis

43 Diffusion plate

MJ Light emitting module

21 Mounting substrate

22 LED

24 Diffusion lens

25 Connector

42 Reflective sheet

42C Cover section

59 Liquid crystal display panel

69 Display device

89 Television receiver

1. An illumination device, comprising:
a diffusion plate;
a chassis supporting said diffusion plate;
light sources disposed on said chassis to emit light towards said diffusion plate; and
a reflective sheet disposed on mounting substrates that are arranged on said chassis to reflect light emitted from said light sources toward said diffusion plate,
wherein said mounting substrates are electrically connected to each other by a connector, and a cover section that receives and covers said connector is formed in said reflective sheet.

2. The illumination device according to claim 1, wherein said cover section has a slope.

3. The illumination device according to claim 1, wherein said cover section has a dome-shaped cross-section.

4. The illumination device according to claim 1, wherein said cover section has a triangular cross-section.

5. The illumination device according to claim 1, wherein said cover section has a trapezoidal cross-section.

6. The illumination device according to claim 1, wherein said cover section has a quadrangular cross-section.

7. The illumination device according to claim 1, wherein a plurality of said connectors are provided, and said cover section has a continuous shape used commonly for the plurality of said connectors.

8. The illumination device according to claim 1, wherein a cut and raised section that is formed by making a cut in said reflective sheet, and that is lifted by said connectors constitutes said cover section.

9. The illumination device according to claim 8, wherein the cut in said reflective sheet has an H-shape.

10. The illumination device according to claim 8, wherein the cut in said reflective sheet has an X-shape.

11. The illumination device according to claim 8, wherein the cut in said reflective sheet has a cross-shape.

12. The illumination device according to claim 8, wherein the cut in said reflective sheet forms said cut and raised section in an L-shape.

13. The illumination device according to claim 8, wherein the cut in said reflective sheet forms said cut and raised section in a concave shape.

14. The illumination device according to claim 8, wherein the cut in said reflective sheet forms said cut and raised section in a convex shape.

15. The illumination device according to claim 8, wherein the cut in said reflective sheet forms said cut and raised section in a triangle shape.

16. The illumination device according to claim 8, wherein the cut in said reflective sheet forms said cut and raised section in a quadrangle shape.

17. The illumination device according to claim 8, wherein the cut in said reflective sheet forms said cut and raised section in a claw shape.

18. The illumination device according to claim 8, wherein the cut in said reflective sheet is formed by a straight line.

19. The illumination device according to claim 8, wherein the cut in said reflective sheet is formed by a curved line.

20. The illumination device according to claim 1, wherein said light sources are constituted of light emitting modules including light emitting elements arranged on said mounting substrates, and diffusion lenses that cover the light emitting elements.

21. The illumination device according to claim 20, wherein an LED is used as said light emitting element.

22. The illumination device according to claim 21, wherein said LED is configured such that a fluorescent member having its emission peak in a yellow region is applied to a blue light emitting chip to emit white light.

23. The illumination device according to claim 21, wherein said LED is configured such that a fluorescent member having its emission peaks in green and red regions is applied to a blue light emitting chip to emit white light.

24. The illumination device according to claim 21, wherein said LED is configured such that a fluorescent member having its emission peaks in a green region is applied to a blue light emitting chip, and a red light emitting chip is combined thereto, to emit white light.

25. The illumination device according to claim 21, wherein said LED is configured such that light emitting chips of respective colors of blue, green and red are combined so as to emit white light.

26. The illumination device according to claim 21, wherein said LED is an LED in which an ultraviolet light chip is combined with a fluorescent member.

27. The illumination device according to claim 26, wherein said LED is configured such that a fluorescent member having its emission peaks in blue, green, and red regions is applied to an ultraviolet light chip to emit white light.

28. The illumination device according to claim 1, wherein a plurality of said mounting substrates are disposed, and adjacent mounting substrates are connected to each other by said connector.

29. The illumination device according to claim 28, wherein said mounting substrates are connected to a power source through said connector.

30. The illumination device according to claim 28, wherein said connector is constituted of a combination of connector halves, one of which is attached to one of said adjacent mounting substrates and the other is attached to the other mounting substrate, and at least one of said connector halves protrudes outward beyond an edge of said mounting substrate to which said one of said connector halves is attached.

31. The illumination device according to claim 28, wherein said connector has an outer surface in a light color.

32. The illumination device according to claim 28, wherein said connector has an outer surface in a dark color.

33. A display device, comprising the illumination device according to claim 1; and a display panel that receives light from said illumination device.

34. The display device according to claim 33, wherein said display panel is a liquid crystal display panel.

35. A television receiver, comprising the display device according to claim 33.
